(19) United States
(12) Patent Application Publication
(10) Pub. No.: US 2026/0028844 A1
(43) Pub. Date: Jan. 29, 2026

(54) POOL ROBOT CONTROL METHOD AND APPARATUS, STORAGE MEDIUM, AND POOL ROBOT

(71) Applicant: XINGMAI INNOVATION TECHNOLOGY (SUZHOU) CO., LTD., Suzhou (CN)

(72) Inventor: Shilei ZHANG, Suzhou (CN)

(73) Assignee: XINGMAI INNOVATION TECHNOLOGY (SUZHOU) CO., LTD., Suzhou (CN)

(21) Appl. No.: 19/342,629

(22) Filed: Sep. 28, 2025

Related U.S. Application Data
(63) Continuation of application No. PCT/CN2023/116834, filed on Sep. 4, 2024.

(30) Foreign Application Priority Data
Jun. 27, 2023 (CN) 2023107686783

(51) Int. Cl. E04H 4/16; G05D 1/648; G05D 1/689; G05D 105/10; G05D 105/80; G05D 107/00; G06T 7/70; G06V 20/05

(52) U.S. Cl. CPC E04H 4/1654; G05D 1/648; G05D 1/6484; G06T 7/70; G06V 20/05; G05D 1/6486; G05D 2105/10; G05D 2107/29; G06V 2201/07

(57) ABSTRACT

Embodiments of the present disclosure provide a pool robot control method and apparatus, a storage medium, and a pool robot. The method includes: obtaining image information of a target water region captured by a pool robot, where the pool robot operates in the target water region; analyzing the image information to determine an analysis result; and determining a target position of a target object if the analysis result indicates that there is the target object in the target water region, and controlling the pool robot to move to the target position and perform a target operation corresponding to a type of the target object.

### CROSS-REFERNCE TO RELATED APPLICATIONS

The present disclosure is a continuation of International Patent Application No. PCT/CN2023/116834, filed with the World Intellectual Property Organization on Sep. 4, 2023, which claims priority to Chinese patent application No. CN202310768678.3, filed on Jun. 27, 2023 and entitled “POOL ROBOT CONTROL METHOD AND APPARATUS, STORAGE MEDIUM, AND POOL ROBOT”, which is incorporated herein by reference in its entirety.

### TECHNICAL FIELD

Embodiments of the present disclosure relate to the field of computers, and specifically, to a pool robot control method and apparatus, a storage medium, and a pool robot.

### BACKGROUND

A pool robot in a related technology can perform one or more tasks in a pool (for example, performing disinfection and performing cleaning). However, when the pool robot performs an operation on a specific object, the pool robot cannot quickly determine a position of the object, affecting efficiency in performing the operation.

In the related technology, an effective solution to resolve the above problem has not been proposed.

### SUMMARY

Embodiments of the present disclosure provide a pool robot control method and apparatus, a storage medium, and a pool robot to at least resolve a problem of inefficiency of a pool robot in performing an operation on a specific object in a related technology.

According to an embodiment of the present disclosure, a pool robot control method is provided. The method includes: obtaining image information of a target water region captured by a pool robot, where the pool robot operates in the target water region; analyzing the image information to determine an analysis result; and determining a target position of a target object if the analysis result indicates that there is the target object in the target water region, and controlling the pool robot to move to the target position and perform a target operation corresponding to a type of the target object.

In an example embodiment, the obtaining image information of a target water region captured by a pool robot includes: obtaining the image information of the target water region captured by the pool robot when the pool robot operates in a first operation mode. The first operation mode is a mode in which the pool robot operates between a plurality of preset positions along a random route based on a preset time period.

In an example embodiment, the determining a target position of a target object if the analysis result indicates that there is the target object in the target water region, and controlling the pool robot to move to the target position and perform a target operation corresponding to a type of the target object includes: if the analysis result indicates that there is the target object in the target water region, determining the target position based on the image information; and controlling the pool robot to move to the target position and perform the target operation corresponding to the type of the target object.

In an example embodiment, after the obtaining image information of a target water region captured by a pool robot, the method further includes: determining a pixel coordinate of the target object in each of a plurality of frames of images to obtain a plurality of pixel coordinates, where the image information includes the plurality of frames of images; converting and mapping the plurality of pixel coordinates to a camera device coordinate system based on a first configuration parameter of a camera device of the pool robot to obtain a plurality of mapped coordinates, where the first configuration parameter includes a parameter existing when the image is captured; and determining the target position of the target object in the target water region based on the plurality of mapped coordinates and a second configuration parameter of the camera device. The second configuration parameter includes pose information existing when the camera device captures the image. The pose information includes a rotation matrix and a translation vector.

In an example embodiment, the converting and mapping the plurality of pixel coordinates to a camera device coordinate system based on a first configuration parameter of a camera device of the pool robot to obtain a plurality of mapped coordinates includes: converting and mapping the plurality of pixel coordinates to normalized coordinates in the camera device coordinate system to obtain the plurality of mapped coordinates; or converting and mapping the plurality of pixel coordinates to image plane coordinates in the camera device coordinate system to obtain the plurality of mapped coordinates.

In an example embodiment, the obtaining image information of a target water region captured by a pool robot includes: obtaining the image information of the target water region captured by the pool robot when the pool robot operates in a second operation mode. The second operation mode is a mode in which the pool robot operates between a plurality of preset positions along a fixed route based on a preset time period.

In an example embodiment, the determining a target position of a target object if the analysis result indicates that there is the target object in the target water region, and controlling the pool robot to move to the target position and perform a target operation corresponding to a type of the target object includes: when the pool robot operates in the second operation mode, determining the target position of the target object if the analysis result indicates that there is the target object in the target water region, and controlling the pool robot to move to the target position and perform the target operation corresponding to the type of the target object.

In an example embodiment, the determining a target position of a target object if the analysis result indicates that there is the target object in the target water region, and controlling the pool robot to move to the target position and perform a target operation corresponding to a type of the target object includes: after the pool robot operates in a second operation mode, marking positions of a plurality of target objects on a map if the analysis result indicates that there is the plurality of target objects in the target water region, where the map is constructed in a process in which the pool robot operates in the target water region; determining an operation route based on the positions of the plurality of target objects; and controlling the pool robot to move to the positions of the plurality of target objects along the operation route and perform a target operation corresponding to a type of each target object.

In an example embodiment, the determining an operation route based on the positions of the plurality of target objects includes: inputting the positions of the plurality of target objects to a target shortest route model to obtain the operation route. The operation route is a shortest operation route in which the pool robot passes through the positions of the plurality of target objects.

In an example embodiment, the target shortest route model is determined in the following manner: defining an objective function as a length of the operation route; taking a plurality of randomly combined operation routes as parents and a plurality of randomly re-combined operation routes as offspring; and determining the target shortest route model based on the parents and the offspring.

In an example embodiment, before the obtaining image information of a target water region captured by a pool robot, the method further includes: controlling the pool robot to perform the target operation along an edge in the target water region; and after it is determined that the pool robot completes the target operation along the edge, controlling the pool robot to perform a patrolling operation in the target water region. The patrolling operation includes controlling the pool robot to capture the image information in the target water region.

In an example embodiment, before the obtaining image information of a target water region captured by a pool robot, the method further includes: controlling the pool robot to perform a task in the target water region, where the task includes performing the target operation along an edge of the target water region, performing the target operation in the target water region along a planned route, and performing the target operation along the edge of the target water region again; and after it is determined that the pool robot completes the task, controlling the pool robot to perform a patrolling operation in the target water region. The patrolling operation includes controlling the pool robot to capture the image information in the target water region.

In an example embodiment, the target object is determined in the following manner: inputting the image information to a target network model to obtain feature information of an object included in the image information output by the target network model, where the feature information includes a spatial feature and a semantic feature of the object; and determining the target object based on the feature information of the object.

In an example embodiment, the target network model is trained in the following manner: obtaining M frames of sample images, where each frame of sample image includes a preset object, and M is a natural number greater than or equal to one; marking the preset object in each frame of sample image to obtain M frames of marked sample images; and training an original network model based on the M frames of marked sample images to obtain the target network model.

According to another embodiment of the present disclosure, a pool robot control apparatus is provided. The apparatus includes: an obtaining module configured to obtain image information of a target water region captured by a pool robot, where the pool robot operates in the target water region; an analysis module configured to analyze the image information to determine an analysis result; and a determining module configured to determine a target position of a target object if the analysis result indicates that there is the target object in the target water region, and control the pool robot to move to the target position and perform a target operation corresponding to a type of the target object.

In an example embodiment, the obtaining module includes a first obtaining sub-module configured to obtain the image information of the target water region captured by the pool robot when the pool robot operates in a first operation mode. The first operation mode is a mode in which the pool robot operates between a plurality of preset positions along a random route based on a preset time period.

In an example embodiment, the determining module includes: a first determining sub-module configured to determine the target position based on the image information if the analysis result indicates that there is the target object in the target water region and a control sub-module configured to control the pool robot to move to the target position and perform the target operation corresponding to the type of the target object.

In an example embodiment, the obtaining module includes a second obtaining sub-module configured to obtain the image information of the target water region captured by the pool robot when the pool robot operates in a second operation mode. The second operation mode is a mode in which the pool robot operates between a plurality of preset positions along a fixed route based on a preset time period.

In an example embodiment, the determining module includes a second determining sub-module configured to: when the pool robot operates in the second operation mode, determine the target position of the target object if the analysis result indicates that there is the target object in the target water region, and control the pool robot to move to the target position and perform the target operation corresponding to the type of the target object.

In an example embodiment, the apparatus is further configured to: after obtaining the image information of the target water region captured by the pool robot, determine a pixel coordinate of the target object in each of a plurality of frames of images to obtain a plurality of pixel coordinates, where the image information includes the plurality of frames of images; convert and map the plurality of pixel coordinates to a camera device coordinate system based on a first configuration parameter of a camera device of the pool robot to obtain a plurality of mapped coordinates, where the first configuration parameter includes a parameter existing when the image is captured; and determine the target position of the target object in the target water region based on the plurality of mapped coordinates and a second configuration parameter of the camera device. The second configuration parameter includes pose information existing when the camera device captures the image. The pose information includes a rotation matrix and a translation vector.

In an example embodiment, the plurality of pixel coordinates are converted and mapped to the camera device coordinate system based on the first configuration parameter of the camera device of the pool robot in the following manner, to obtain the plurality of mapped coordinates: converting and mapping the plurality of pixel coordinates to normalized coordinates in the camera device coordinate system to obtain the plurality of mapped coordinates; or converting and mapping the plurality of pixel coordinates to image plane coordinates in the camera device coordinate system to obtain the plurality of mapped coordinates.

In an example embodiment, the determining module further includes: a third determining sub-module configured to: after the pool robot operates in a second operation mode, mark positions of a plurality of target objects on a map if the analysis result indicates that there is the plurality of target objects in the target water region, where the map is constructed in a process in which the pool robot operates in the target water region; a fourth determining sub-module configured to determine an operation route based on the positions of the plurality of target objects; and a control sub-module configured to control the pool robot to move to the positions of the plurality of target objects along the operation route and perform a target operation corresponding to a type of each target object.

In an example embodiment, the operation route is determined based on the positions of the plurality of target objects in the following manner: inputting the positions of the plurality of target objects to a target shortest route model to obtain the operation route. The operation route is a shortest operation route in which the pool robot passes through the positions of the plurality of target objects.

In an example embodiment, the target shortest route model is determined in the following manner: defining an objective function as a length of the operation route; taking a plurality of randomly combined operation routes as parents and a plurality of randomly re-combined operation routes as offspring; and determining the target shortest route model based on the parents and the offspring.

In an example embodiment, the apparatus further includes: a first control module configured to: before the image information of the target water region captured by the pool robot is obtained, control the pool robot to perform the target operation along an edge in the target water region; and a second control module configured to: after it is determined that the pool robot completes the target operation along the edge, control the pool robot to perform a patrolling operation in the target water region. The patrolling operation includes controlling the pool robot to capture the image information in the target water region.

In an example embodiment, the apparatus is further configured to: before obtaining the image information of the target water region captured by the pool robot, control the pool robot to perform a task in the target water region, where the task includes performing the target operation along an edge of the target water region, performing the target operation in the target water region along a planned route, and performing the target operation along the edge of the target water region again; and after it is determined that the pool robot completes the task, control the pool robot to perform a patrolling operation in the target water region. The patrolling operation includes controlling the pool robot to capture the image information in the target water region.

In an example embodiment, the target object is determined in the following manner: inputting the image information to a target network model to obtain feature information of an object included in the image information output by the target network model, where the feature information includes a spatial feature and a semantic feature of the object; and determining the target object based on the feature information of the object.

In an example embodiment, the target network model is trained in the following manner: obtaining M frames of sample images, where each frame of sample image includes a preset object, and M is a natural number greater than or equal to one; marking the preset object in each frame of sample image to obtain M frames of marked sample images; and training an original network model based on the M frames of marked sample images to obtain the target network model.

According to still another embodiment of the present disclosure, a computer-readable storage medium is further provided. The computer-readable storage medium stores a computer program. When the computer program is run, steps in any one of the method embodiments are performed.

According to still another embodiment of the present disclosure, a pool robot is further provided. The pool robot includes a memory and a processor. The memory stores a computer program. The processor is configured to: when executing the computer program, perform steps in any one of the method embodiments.

According to the present disclosure, the image information of the target water region captured by the pool robot is analyzed, so that the target object can be identified, and the position of the target object can be determined. Further, the pool robot can be controlled to directly move to the position of the target object and perform the target operation on the target object. In this way, the following case can be avoided: The pool robot cannot position the target object and therefore can only re-clean the entire target water region along a preset route.

### BRIEF DESCRIPTION OF THE DRAWINGS

FIG. 1 is a block diagram of a hardware structure of a mobile terminal for performing a pool robot control method according to an embodiment of the present disclosure;

FIG. 2 is a flowchart of a pool robot control method according to an embodiment of the present disclosure; and

FIG. 3 is a block diagram of a structure of a pool robot control apparatus according to an embodiment of the present disclosure.

### DETAILED DESCRIPTION

Embodiments of the present disclosure are described in detail in the following with reference to the accompanying drawings.

It should be noted that in this specification, claims, and the accompanying drawings of the present disclosure, the terms “first”, “second”, and the like are intended to distinguish between similar objects but do not necessarily indicate a specific order or sequence.

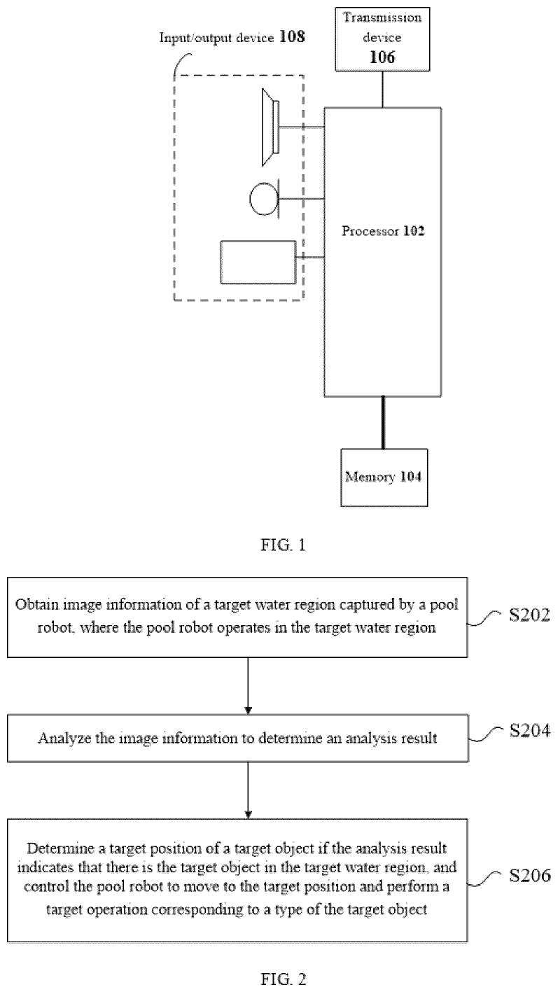

The method provided in embodiments of the present disclosure may be performed by a mobile terminal, a computer terminal, or a similar computing apparatus. An example in which the method is performed by the mobile terminal is used. FIG. 1 is a block diagram of a hardware structure of a mobile terminal for performing a pool robot control method according to an embodiment of the present disclosure. As shown in FIG. 1, the mobile terminal may include one or more (only one processor is shown in FIG. 1) processors 102 (the processor 102 may include, but is not limited to, a processing apparatus such as a microprocessor unit or a field-programmable gate array FPGA) and a memory 104 configured to store data. The mobile terminal may further include a transmission device 106 with a communication function and an input/output device 108. A person skilled in the art may understand that the structure shown in FIG. 1 is only an example and does not constitute a limitation on the structure of the mobile terminal. For example, the mobile terminal may include more or fewer components than those shown in FIG. 1 or have a configuration different from that shown in FIG. 1.

The memory 104 may be configured to store a computer program, for example, a software program of an application software and modules, for example, a computer program corresponding to the pool robot control method in embodiments of the present disclosure. The processor 102 executes the computer program stored in the memory 104 to execute various functional applications and data processing, that is, to implement the above method. The memory 104 may include a high-speed random access memory, a non-volatile memory, for example, one or more magnetic storage apparatuses, a flash memory, or another non-volatile solid-state memory. In some examples, the memory 104 may further include memories that are remotely disposed relative to the processor 102, and these remote memories may be connected to the mobile terminal through a network. Examples of the foregoing network include, but are not limited to, the Internet, an enterprise intranet, a local area network, a mobile communication network, and a combination thereof.

The transmission device 106 is configured to receive or send data through one network. Specific examples of the network may include a wireless network provided by a communication provider of the mobile terminal. In one example, the transmission device 106 includes a network interface controller (Network Interface Controller, NIC for short) and may be connected to other network devices through a base station to communicate with the Internet. In one example, the transmission device 106 may be a radio frequency (Radio Frequency, RF for short) module configured to communicate with the Internet in a wireless manner.

An embodiment provides a pool robot control method. FIG. 2 is a schematic flowchart of the method according to an embodiment of the present disclosure. As shown in FIG. 2, the method may include the following steps.

Step S202: Obtain image information of a target water region captured by a pool robot, where the pool robot operates in the target water region.

Step S204: Analyze the image information to determine an analysis result.

Step S206: Determine a target position of a target object if the analysis result indicates that there is the target object in the target water region, and control the pool robot to move to the target position and perform a target operation corresponding to a type of the target object.

The above steps may be executed by a controller of the pool robot, a processor having data processing and signal interaction capabilities, or another processing device or processing unit having a similar processing capability. However, this is not limited thereto.

In the above embodiment, the device, of the pool robot, configured to perform capturing is a highly waterproofed camera. The camera may be disposed at a front end, a side surface, a top, or the like of the pool robot. A specific disposition position of the camera is not limited. The target water region is, but is not limited to, a swimming pool, an ornamental reservoir, a wild pool, or the like. The pool robot may be located on a water surface of the target water region or a bottom of the target water region, or suspended in the target water region, or located on a wall of a swimming pool when the target water region is the swimming pool. The image information may be analyzed in a manner of identifying the image information by using a pre-trained network model or identifying the image information by using other image analysis devices. The target object includes, but is not limited to, all types of debris, for example, a plastic bottle cap and a leaf. The image information may be a picture or a video including a plurality of frames of images. The image information is obtained in real time in a process in which the robot patrols the target water region. The target operation includes, but is not limited to, a cleaning operation, a disinfection operation, an alarm operation, and the like. For example, the pool robot may clean various types of debris (for example, a plastic bottle cap and a leaf), disinfect a region in which the target object is located and that needs to be disinfected, and send an alarm signal when detecting that the target object is a person or an animal that accidentally falls into the water.

Optionally, the analyzing the image information to determine an analysis result includes: inputting the image information to a target network model to obtain feature information of an object included in the image information output by the target network model, where the feature information includes a spatial feature and a semantic feature of the object included in each frame of image; and determining the target object based on the feature information of the object included in each frame of image. In this embodiment, the spatial feature is a shallow visual feature and includes a texture, a color, a shape, a spatial relationship, and the like, and the semantic feature includes a deep relationship between objects.

Optionally, a method for training the target network model includes: obtaining M frames of sample images, where each frame of sample image includes a preset object, and M is a natural number greater than or equal to one; marking the preset object in each frame of sample image to obtain M frames of marked sample images; and training an original network model based on the M frames of marked sample images to obtain the target network model. In this embodiment, the original network model may be YOLOv3 (a third version of a YOLO algorithm) or FasterRCNN (an optimized version of a FastRCNN algorithm, where a region of interest is generated by using a region proposal network). Certainly, the algorithm is only an example, and the original network model may be any model that can satisfy an identification requirement. The sample image may be a network resource, manually captured data, or an AI-generated training material. The target object in the sample image may be manually marked. Each sample image may include a plurality of target objects.

According to this embodiment of the present disclosure, the image information of the target water region captured by the pool robot is analyzed, so that the target object can be identified, and the position of the target object can be determined. Further, the pool robot can be controlled to directly move to the position of the target object and perform the target operation on the target object. In this way, the following case can be avoided: The pool robot cannot position the target object and therefore can only re-clean the entire target water region along a preset route.

In an example embodiment, the obtaining image information of a target water region captured by a pool robot includes: obtaining the image information of the target water region captured by the pool robot when the pool robot operates in a first operation mode. The first operation mode is a mode in which the pool robot operates between a plurality of preset positions along a random route based on a preset time period. In the above embodiment, the first operation mode is a mode of performing patrolling along a random path, and the preset time period may be 5 minutes, 6 minutes, or 10 minutes. Certainly, the above time period is only an example, and the preset time period may be any duration that can satisfy a patrolling requirement of the pool robot. For example, when there are three preset positions A, B, and C in the target water region, the first operation mode may be a mode in which the pool robot randomly performs patrolling between the three preset positions A, B, and C for 5 minutes. According to the above embodiment, the pool robot performs patrolling along the random path to determine that there are some target objects in the target water region. This can effectively improve efficiency of the pool robot in processing a specific object.

In an example embodiment, the determining a target position of a target object if the analysis result indicates that there is the target object in the target water region, and controlling the pool robot to move to the target position and perform a target operation corresponding to a type of the target object includes: if the analysis result indicates that there is the target object in the target water region, determining the target position based on the image information; and controlling the pool robot to move to the target position and perform the target operation corresponding to the type of the target object.

Optionally, a method for determining the target position based on the image information includes: determining a pixel coordinate of the target object in each frame of image to obtain N pixel coordinates, where the image information includes the image; converting and mapping the N pixel coordinates to a camera device coordinate system based on a first configuration parameter of a camera device of the pool robot to obtain N mapped coordinates, where the first configuration parameter includes a parameter existing when the image information is captured; and determining the target position based on the N mapped coordinates and a second configuration parameter of the camera device. The second configuration parameter includes pose information existing when the camera device captures the image information. The pose information includes a rotation matrix and a translation vector. In this embodiment, the converting and mapping the pixel coordinates to a camera device coordinate system may be converting the pixel coordinates to normalized coordinates in the camera device coordinate system (the pixel coordinates are converted to the normalized coordinates, so that subsequent calculation of the target position can be simplified), or converting the pixel coordinates to image plane coordinates in the camera device coordinate system (that is, the pixel coordinates are converted to the normalized coordinates based on a focal length of the camera device, and in this case, a distance between the image plane coordinates is a distance between corresponding pixel coordinates). According to the above embodiment, position information of the target object is determined based on the image information, so that some target objects in the target water region are quickly positioned. This can effectively improve the efficiency of the pool robot in processing a specific object.

In an example embodiment, the obtaining image information of a target water region captured by a pool robot includes: obtaining the image information of the target water region captured by the pool robot when the pool robot operates in a second operation mode. The second operation mode is a mode in which the pool robot operates between a plurality of preset positions along a fixed route based on a preset time period. In the above embodiment, the second operation mode is a mode of performing patrolling along a fixed path, and the preset time period may be 5 minutes, 6 minutes, or 10 minutes. Certainly, the above time period is only an example, and the preset time period may be any duration that can satisfy a patrolling requirement of the pool robot. For example, when there are three preset positions A, B, and C in the target water region, the second operation mode may be a mode in which the pool robot performs patrolling along a preset fixed path of A→B→C for 10 minutes. According to the above embodiment, the pool robot performs patrolling along the fixed path to determine that there are some target objects in the target water region. This can effectively improve efficiency of the pool robot in processing a specific object.

In an example embodiment, the determining a target position of a target object if the analysis result indicates that there is the target object in the target water region, and controlling the pool robot to move to the target position and perform a target operation corresponding to a type of the target object includes: when the pool robot operates in the second operation mode, determining the target position of the target object if the analysis result indicates that there is the target object in the target water region, and controlling the pool robot to move to the target position and perform the target operation corresponding to the type of the target object. According to the above embodiment, position information of the target object is determined based on the image information, so that some target objects in the target water region are quickly positioned. This can effectively improve the efficiency of the pool robot in processing a specific object.

In an example embodiment, the determining a target position of a target object if the analysis result indicates that there is the target object in the target water region, and controlling the pool robot to move to the target position and perform a target operation corresponding to a type of the target object includes: after the pool robot operates in a second operation mode, marking positions of a plurality of target objects on a map if the analysis result indicates that there is the plurality of target objects in the target water region, where the map is constructed in a process in which the pool robot operates in the target water region; determining an operation route based on the positions of the plurality of target objects; and controlling the pool robot to move to the positions of the plurality of target objects along the operation route and perform a target operation corresponding to a type of each target object. In the above embodiment, optionally, the determining an operation route based on the positions of the plurality of target objects includes: inputting the positions of the plurality of target objects to a target shortest route model to obtain the operation route. The operation route is a shortest operation route in which the pool robot passes through the positions of the plurality of target objects. According to the target shortest route model, the shortest operation route that traverses the plurality of positions is calculated based on a heuristic algorithm (for example, a genetic algorithm or an ant colony algorithm). For example, a method for determining a shortest route based on the genetic algorithm includes: defining an objective function as a length of the operation route; taking a plurality of randomly combined operation routes as parents and a plurality of randomly re-combined operation routes as offspring; choosing offspring with a better value of the objective function as a new parent; and performing iteration continuously and determining the offspring as the operation route when a value of the objective function of the offspring cannot significantly exceed that of the parent. The positions of the target objects are recorded in a process of performing patrolling along the fixed path, and route planning is performed after patrolling is completed. This can shorten processing distance and effectively improve cleaning efficiency of the pool robot.

In an example embodiment, before the obtaining image information of a target water region captured by a pool robot, the method further includes: controlling the pool robot to perform the target operation along an edge in the target water region; and after it is determined that the pool robot completes the target operation along the edge, controlling the pool robot to perform a patrolling operation in the target water region. The patrolling operation includes controlling the pool robot to capture the image information in the target water region. In the above embodiment, a task of the pool robot includes performing the target operation along an edge of the target water region, performing the target operation in the target water region along a planned route, and performing the target operation along the edge of the target water region again. Performing the target operation along the edge may correspond to performing the target operation along the edge of the target water region again in the task. In other words, the patrolling operation may be performed after the pool robot completes the task. According to the above embodiment, the pool robot performs patrolling after performing the task, so that supplementary cleaning can be performed on the target water region. This effectively improves a working effect of the pool robot.

Based on the foregoing descriptions of the implementations, a person skilled in the art may clearly understand that the method in the above embodiment may be implemented by software in addition to a necessary universal hardware platform or by hardware only. In many cases, the former is a preferred implementation. Based on such understanding, the technical solutions of the present disclosure can be essentially or the part that contributes to the related technology can be embodied in a form of a software product. This computer software product is stored in a storage medium (for example, a ROM/RAM, a magnetic disk, or a compact disc), and includes several instructions for instructing a terminal device (which may be a mobile phone, a computer, a server, or a network device) to perform the method described in embodiments of the present disclosure.

An embodiment further provides a pool robot control apparatus. The apparatus is configured to implement the above embodiments and optional implementations. Some that have been described are not described in detail again. The term “module” used below may be a combination of software and/or hardware that implements a preset function. Although the apparatus described in the following embodiment is preferably implemented in software, it may be conceived that the apparatus is implemented in hardware or a combination of software and hardware.

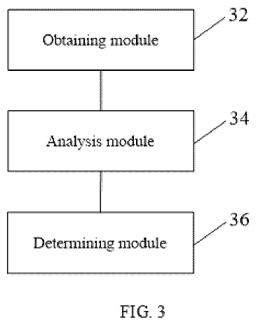

FIG. 3 is a block diagram of a structure of a pool robot control apparatus according to an embodiment of the present disclosure. As shown in FIG. 3, the apparatus includes: an obtaining module 32 configured to obtain image information of a target water region captured by a pool robot, where the pool robot operates in the target water region; an analysis module 34 configured to analyze the image information to determine an analysis result; and a determining module 36 configured to determine a target position of a target object if the analysis result indicates that there is the target object in the target water region, and control the pool robot to move to the target position and perform a target operation corresponding to a type of the target object.

In an example embodiment, the obtaining module includes a first obtaining sub-module configured to obtain the image information of the target water region captured by the pool robot when the pool robot operates in a first operation mode. The first operation mode is a mode in which the pool robot operates between a plurality of preset positions along a random route based on a preset time period.

In an example embodiment, the determining module includes: a first determining sub-module configured to determine the target position based on the image information if the analysis result indicates that there is the target object in the target water region and a control sub-module configured to control the pool robot to move to the target position and perform the target operation corresponding to the type of the target object.

In an example embodiment, the obtaining module includes a second obtaining sub-module configured to obtain the image information of the target water region captured by the pool robot when the pool robot operates in a second operation mode. The second operation mode is a mode in which the pool robot operates between a plurality of preset positions along a fixed route based on a preset time period.

In an example embodiment, the determining module includes a second determining sub-module configured to: when the pool robot operates in the second operation mode, determine the target position of the target object if the analysis result indicates that there is the target object in the target water region, and control the pool robot to move to the target position and perform the target operation corresponding to the type of the target object.

In an example embodiment, the apparatus is further configured to: after obtaining the image information of the target water region captured by the pool robot, determine a pixel coordinate of the target object in each of a plurality of frames of images to obtain a plurality of pixel coordinates, where the image information includes the plurality of frames of images; convert and map the plurality of pixel coordinates to a camera device coordinate system based on a first configuration parameter of a camera device of the pool robot to obtain a plurality of mapped coordinates, where the first configuration parameter includes a parameter existing when the image is captured; and determine the target position of the target object in the target water region based on the plurality of mapped coordinates and a second configuration parameter of the camera device. The second configuration parameter includes pose information existing when the camera device captures the image. The pose information includes a rotation matrix and a translation vector.

In an example embodiment, the plurality of pixel coordinates are converted and mapped to the camera device coordinate system based on the first configuration parameter of the camera device of the pool robot in the following manner, to obtain the plurality of mapped coordinates: converting and mapping the plurality of pixel coordinates to normalized coordinates in the camera device coordinate system to obtain the plurality of mapped coordinates; or converting and mapping the plurality of pixel coordinates to image plane coordinates in the camera device coordinate system to obtain the plurality of mapped coordinates.

In an example embodiment, the determining module further includes: a third determining sub-module configured to: after the pool robot operates in a second operation mode, mark positions of a plurality of target objects on a map if the analysis result indicates that there is the plurality of target objects in the target water region, where the map is constructed in a process in which the pool robot operates in the target water region; a fourth determining sub-module configured to determine an operation route based on the positions of the plurality of target objects; and a control sub-module configured to control the pool robot to move to the positions of the plurality of target objects along the operation route and perform a target operation corresponding to a type of each target object.

In an example embodiment, the operation route is determined based on the positions of the plurality of target objects in the following manner: inputting the positions of the plurality of target objects to a target shortest route model to obtain the operation route. The operation route is a shortest operation route in which the pool robot passes through the positions of the plurality of target objects.

In an example embodiment, the target shortest route model is determined in the following manner: defining an objective function as a length of the operation route; taking a plurality of randomly combined operation routes as parents and a plurality of randomly re-combined operation routes as offspring; and determining the target shortest route model based on the parents and the offspring.

In an example embodiment, the apparatus further includes: a first control module configured to: before the image information of the target water region captured by the pool robot is obtained, control the pool robot to perform the target operation along an edge in the target water region; and a second control module configured to: after it is determined that the pool robot completes the target operation along the edge, control the pool robot to perform a patrolling operation in the target water region. The patrolling operation includes controlling the pool robot to capture the image information in the target water region.

In an example embodiment, the apparatus is further configured to: before obtaining the image information of the target water region captured by the pool robot, control the pool robot to perform a task in the target water region, where the task includes performing the target operation along an edge of the target water region, performing the target operation in the target water region along a planned route, and performing the target operation along the edge of the target water region again; and after it is determined that the pool robot completes the task, control the pool robot to perform a patrolling operation in the target water region. The patrolling operation includes controlling the pool robot to capture the image information in the

In an example embodiment, the target object is determined in the following manner: inputting the image information to a target network model to obtain feature information of an object included in the image information output by the target network model, where the feature information includes a spatial feature and a semantic feature of the object; and determining the target object based on the feature information of the object.

In an example embodiment, the target network model is trained in the following manner: obtaining M frames of sample images, where each frame of sample image includes a preset object, and M is a natural number greater than or equal to one; marking the preset object in each frame of sample image to obtain M frames of marked sample images; and training an original network model based on the M frames of marked sample images to obtain the target network model.

It should be noted that each module may be implemented by software or hardware, and for the latter, it may be implemented in the following manner: All modules are located in a same processor, or various modules are located in different processors respectively in a form of any combination. However, this is not limited thereto.

An embodiment of the present disclosure further provides a computer-readable storage medium. The computer-readable storage medium stores a computer program. When the computer program is run, steps in any one of the method embodiments are performed.

In an example embodiment, the computer-readable storage medium may include, but is not limited to, any medium that can store the computer program, for example, a USB flash drive, a read-only memory (Read-Only Memory, ROM for short), a random access memory (Random Access Memory, RAM for short), a removable hard disk, a magnetic disk, or a compact disc.

An embodiment of the present disclosure further provides a pool robot. The pool robot includes a memory and a processor. The memory stores a computer program. The processor is configured to: when executing the computer program, perform steps in any one of the method embodiments.

In an example embodiment, the pool robot may further include a transmission device and an input/output device. The transmission device is connected to the processor, and the input/output device is connected to the processor.

For details of specific examples in this embodiment, refer to the examples described in the above embodiments and example implementations. Details are not described in this embodiment again.

It is clear that a person skilled in the art should understand that the modules or steps in the present disclosure may be implemented by a general-purpose computing apparatus, and the modules may be integrated on a single computing apparatus or distributed on a network including a plurality of computing apparatuses, or may be implemented by program code executed by a computing apparatus. In this way, the program code can be stored in a storage apparatus and executed by the computing apparatus. In addition, in some cases, the shown or described steps may be performed in an order different from the above order, or the modules are respectively manufactured into various integrated circuit modules, or a plurality of modules are manufactured into a single integrated circuit module. In this way, the present disclosure is not limited to any particular combination of hardware and software.

The foregoing descriptions are merely optional embodiments of the present disclosure, but are not intended to limit the present disclosure. For a person skilled in the art, the present disclosure may have various modifications and variations. Any modification, equivalent replacement, improvement, or the like made without departing from the principle of the present disclosure shall fall within the protection scope of the present disclosure.

What is claimed is:

1. A pool robot control method, comprising:
obtaining image information of a target water region captured by a pool robot, wherein the pool robot operates in the target water region, wherein the image information comprises a frame of image or a plurality of frames of images;
analyzing the image information to determine an analysis result; and
determining a target position of a target object if the analysis result indicates that there is the target object in the target water region, and controlling the pool robot to move to the target position and perform a target operation corresponding to a type of the target object.

2. The method according to claim 1, wherein the obtaining image information of a target water region captured by a pool robot comprises:
obtaining the image information of the target water region captured by the pool robot when the pool robot operates in a first operation mode, wherein the first operation mode is a mode in which the pool robot operates between a plurality of preset positions along a random route based on a preset time period.

3. The method according to claim 1, wherein the determining a target position of a target object if the analysis result indicates that there is the target object in the target water region, and controlling the pool robot to move to the target position and perform a target operation corresponding to a type of the target object comprises:
if the analysis result indicates that there is the target object in the target water region, determining the target position based on the image information; and
controlling the pool robot to move to the target position and perform the target operation corresponding to the type of the target object.

4. The method according to claim 1, wherein the obtaining image information of a target water region captured by a pool robot comprises:
obtaining the image information of the target water region captured by the pool robot when the pool robot operates in a second operation mode, wherein the second operation mode is a mode in which the pool robot operates between a plurality of preset positions along a fixed route based on a preset time period.

5. The method according to claim 4, wherein the determining a target position of a target object if the analysis result indicates that there is the target object in the target water region, and controlling the pool robot to move to the target position and perform a target operation corresponding to a type of the target object comprises:
when the pool robot operates in the second operation mode, determining the target position of the target object if the analysis result indicates that there is the target object in the target water region, and controlling the pool robot to move to the target position and perform the target operation corresponding to the type of the target object.

6. The method according to claim 4, wherein the determining a target position of a target object if the analysis result indicates that there is the target object in the target water region, and controlling the pool robot to move to the target position and perform a target operation corresponding to a type of the target object comprises:
after the pool robot operates in the second operation mode, marking positions of a plurality of target objects on a map if the analysis result indicates that there is the plurality of target objects in the target water region, wherein the map is constructed in a process in which the pool robot operates in the target water region;
determining an operation route based on the positions of the plurality of target objects; and
controlling the pool robot to move to the positions of the plurality of target objects along the operation route and perform a target operation corresponding to a type of each target object.

7. The method according to claim 1, wherein before the obtaining image information of a target water region captured by a pool robot, the method further comprises:
controlling the pool robot to perform the target operation along an edge in the target water region; and
after it is determined that the pool robot completes the target operation along the edge, controlling the pool robot to perform a patrolling operation in the target water region, wherein the patrolling operation comprises controlling the pool robot to capture the image information in the target water region.

8. The method according to claim 1, wherein before the obtaining image information of a target water region captured by a pool robot, the method further comprises:
controlling the pool robot to perform a task in the target water region, wherein the task comprises performing the target operation along an edge of the target water region, performing the target operation in the target water region along a planned route, and performing the target operation along the edge of the target water region again; and
after it is determined that the pool robot completes the task, controlling the pool robot to perform a patrolling operation in the target water region, wherein the patrolling operation comprises controlling the pool robot to capture the image information in the target water region.

9. A pool robot control method, wherein a pool robot is configured to perform a cleaning operation in a target water region, and a camera is disposed on the pool robot, wherein the method comprises:
controlling the pool robot to perform a patrolling operation in the target water region, enabling the camera to capture an image of the target water region in a process of performing the patrolling operation, wherein the image is used to determine whether there is a target object in the target water region, wherein the target object needs to be cleaned; and
controlling, if it is determined that there is the target object, the pool robot to move to a target position of the target object and perform the cleaning operation on the target object.

10. The method according to claim 9, further comprising:
controlling the pool robot to perform the cleaning operation in the target water region along an edge of the target water region; and
after the pool robot completes the cleaning operation along the edge of the target water region, controlling the pool robot to perform the patrolling operation in the target water region.

11. The method according to claim 9, wherein the patrolling operation is performed after the pool robot completes a task, wherein the task comprises performing the cleaning operation along an edge of the target water region, performing the cleaning operation in the target water region along a planned route, and performing the cleaning operation along the edge of the target water region again.

12. The method according to claim 9, comprising: if it is determined that there is the target object, controlling the pool robot to directly move to the target position of the target object and perform the cleaning operation on the target object.

13. The method according to claim 9, wherein the controlling the pool robot to perform a patrolling operation in the target water region comprises:
controlling the pool robot to perform the patrolling operation in a first operation mode, wherein the first operation mode is a mode of performing the patrolling operation along a random route.

14. The method according to claim 13, wherein the controlling the pool robot to perform a patrolling operation in the target water region comprises:
controlling the pool robot to perform the patrolling operation in the first operation mode, wherein the first operation mode is a mode in which the pool robot operates between a plurality of preset positions along the random route based on a preset time period.

15. The method according to claim 9, wherein the controlling the pool robot to perform a patrolling operation in the target water region comprises:
controlling the pool robot to perform the patrolling operation in a second operation mode, wherein the second operation mode is a mode of performing the patrolling operation along a fixed route.

16. The method according to claim 15, wherein the controlling the pool robot to perform a patrolling operation in the target water region comprises:
controlling the pool robot to perform the patrolling operation in the second operation mode, wherein the second operation mode is a mode in which the pool robot operates between a plurality of preset positions along the fixed route based on a preset time period.

17. The method according to claim 15, wherein the controlling, if it is determined that there is the target object, the pool robot to move to a target position of the target object and perform the cleaning operation on the target object comprises:
when the pool robot is controlled to perform the patrolling operation in the second operation mode, controlling, if it is determined that there is the target object, the pool robot to move to the target position of the target object and perform the cleaning operation on the target object.

18. The method according to claim 15 comprising: in a process of controlling the pool robot to perform the patrolling operation in the second operation mode, if it is determined that there is the target object, recording the target position of the target object, or after the pool robot is controlled to perform the patrolling operation in the second operation mode, if it is determined that there is a plurality of target objects, marking target positions of the plurality of target objects on a map, wherein the map is constructed in a process in which the pool robot operates in the target water region; and
the controlling, if it is determined that there is the target object, the pool robot to move to a target position of the target object and perform the cleaning operation on the target object comprises: after the patrolling operation is completed, controlling the pool robot to move to the target positions of the plurality of target objects along an operation route and perform the cleaning operation on each target object.

19. The method according to claim 9, comprising: when the pool robot performs the cleaning operation at a water surface or a bottom of the target water region, controlling the pool robot to perform the patrolling operation in the target water region.

20. The method according to claim 9, comprising: if it is determined that there is the target object, determining the target position of the target object and controlling the pool robot to move to the target position of the target object, wherein the image is used to determine the target position of the target object.
